(19) United States
(12) Patent Application Publication
(10) Pub. No.: US 2010/0237070 A1
(43) Pub. Date: Sep. 23, 2010

(54) STORAGE CONTAINER

(76) Inventors: Ryan J. Coonce, Palatine (IL); Jason R. Maxwell, Elgin (IL)

Correspondence Address: THE CLOROX COMPANY, P.O. BOX 24305, OAKLAND, CA, 94623-1305, US

(21) Appl. No.: 12/741,663

(22) PCT Filed: Nov. 20, 2008
(86) PCT No.: PCT/US08/84226

§ 371 Date: May 6, 2010

Related U.S. Application Data
(60) Provisional application No. 60/990,771, filed on Nov. 28, 2007.

(51) Int. Cl. B65D 51/16; B65D 41/16; B29C 70/00

(52) U.S. Cl. 220/203.29; 220/795; 264/255

(57) ABSTRACT

A storage container for storing food items includes a base providing a storage cavity accessible by an opening and a detachable lid for covering the opening and enclosing the storage cavity. The lid may include a one-way valve to facilitate evacuation of the storage cavity after the lid has been attached. To provide a substantially air tight seal between the base and lid, a sealing member is included. The sealing member can be comprised of any suitable resilient material such as a thermoplastic elastomer. The sealing member can be integrally bonded to either the base or the lid by, for example, an overmolding process or a co-extrusion process.

### BACKGROUND

A variety of different containers are available for storing and preserving food items for later consumption. These containers may be intended for commercial use during the distribution of food items, home use for the storing of recently prepared food items, or both. Such containers may be flexible, as in the case of plastic storage bags, or may be comparatively rigid, as in the case of plastic and glass-walled storage containers. Rigid containers of this type may include a base or tray portion that provides a storage cavity for receiving the food items and a detachable lid that may be connected to the base to enclose the storage cavity. An advantage of rigid storage containers is that they can maintain their shape and thereby protect the stored food items from being crushed. Another advantage is that rigid containers are usually easily washable and therefore can be reusable. Also, it is desirable that rigid containers be temperature and microwave resistant to allow for heating, cooling and freezing of the stored food items within the container.

### BRIEF SUMMARY

The storage container includes a base that defines or provides a storage cavity for receiving food items to be stored. The base also provides or delineates an opening through which the storage cavity is accessible. To cover the opening and thereby enclose the storage cavity, the storage container can also include a lid that is detachably connectable to the base. To affect a substantially air tight connection between the base and lid, the storage cavity can include a sealing member made of a thermoplastic elastomer (TPE) or similar material that can be integrally bonded to either of the base or lid. In one aspect, the integral bonding can involve intermolecular bonding between the materials of the storage container and the sealing member.

To facilitate the integral bonding between the storage container and the sealing member, various molding and/or forming techniques can be applied. For example, a component of the storage cavity can be molded in a first step. In a subsequent step, the sealing member can be overmolded onto at least a portion of the storage container component. Once the material of the sealing member has set, the sealing member will be integrally bonded to the storage container component. In another aspect, the storage container component and the sealing member can be co-molded or co-extruded as part of the same step or related series of steps. As the materials of the storage container component and the sealing member set, they will become integrally bonded together.

An advantage of the storage container with an integrally bonded sealing member is that components of the storage container can form a substantially airtight seal about the storage cavity to preserve food items stored therein. Another advantage is that because the sealing member is an integral part of a component of the storage container, it is less likely to be unintentionally detached or separated. A related advantage is that the sealing member can be substantially permanently positioned with respect to the other storage container components so as to form an optimal seal and therefore is less likely to shift so as to disrupt the seal. Another advantage is that because the storage container components and sealing member are formed as integral components, manufacturing and assembly costs can be reduced. Another advantage relates to improved hygiene when cleaning the container. When the sealing member is bonded to the lid or base, the sealing member does not need be removed and cleaned separately. These and related advantages and features of the storage container and integral sealing member will be apparent from the following drawings and detailed description of the embodiments.

### BRIEF DESCRIPTION OF THE DRAWINGS

FIG. 1 is an exploded perspective view of a storage container including a base and a lid, the particular storage container adapted to interface with a vacuum device for evacuating the storage container.

FIG. 2 is a perspective view of the storage container of FIG. 1 with the base and lid attached together and the storage container interfacing with the vacuum device.

FIG. 3 is a cross-sectional view taken along line A-A of FIG. 2 illustrating a tongue and groove coupling formed by the attached base and lid, the tongue and groove coupling including a sealing member therein.

FIG. 4 is a detailed view of the area indicated by circle B-B in FIG. 3 illustrating an intermolecular bonding of the materials of the storage container component and the sealing member.

FIG. 5 is a view of another embodiment of a storage container similar to that of FIG. 3, the storage container including a base and lid releasably coupled together and a sealing member included therebetween.

FIG. 6 is a view of another embodiment of a storage container including a base generally shaped as a cylindrical tub and a lid that is generally circular.

FIG. 7 is a perspective view of another embodiment of a storage container.

FIG. 8 is a cross-sectional view of another embodiment of a base and lid.

FIG. 9 is a cross-sectional view of an anchor for a sealing member.

FIG. 10 is a cross-sectional view of another embodiment of an anchor for a sealing member.

FIG. 11 is a cross-sectional view of another embodiment of an anchor for a sealing member.

### DETAILED DESCRIPTION OF THE EMBODIMENTS

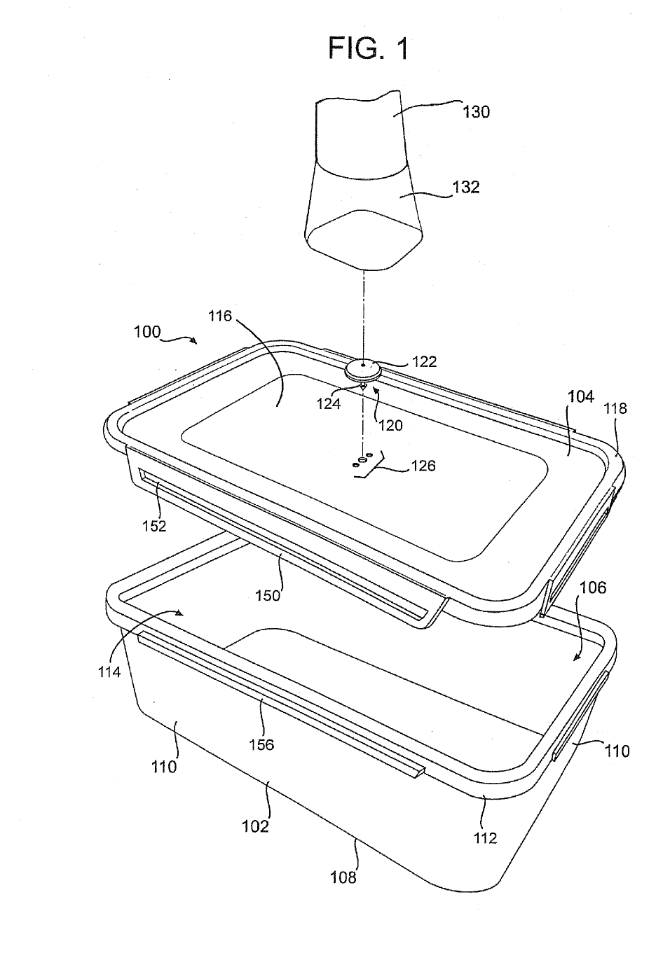

FIG. 1 illustrates an embodiment of a storage container 100 for receiving and storing various items such as, and in particular, food items. The illustrated storage container can be intended for use during commercial distribution, for home use, or both. The components of the storage container 100 include a base 102 and a detachable lid 104 that can be releasably attached to the base. To receive items for storage, the base 102 is shaped to provide a void or storage cavity 106. In the illustrated embodiment, the base 102 includes a bottom wall 108 and four sidewalls 110 that are attached to each other and the bottom wall. The four sidewalls 110 may be arranged orthogonally so that the base 102 has an overall rectangular tray-like appearance. The upper portion or edges of the sidewalls 110 together form an upward directed rim 112 that delineates an opening 114 through which the storage cavity 106 can be accessed.

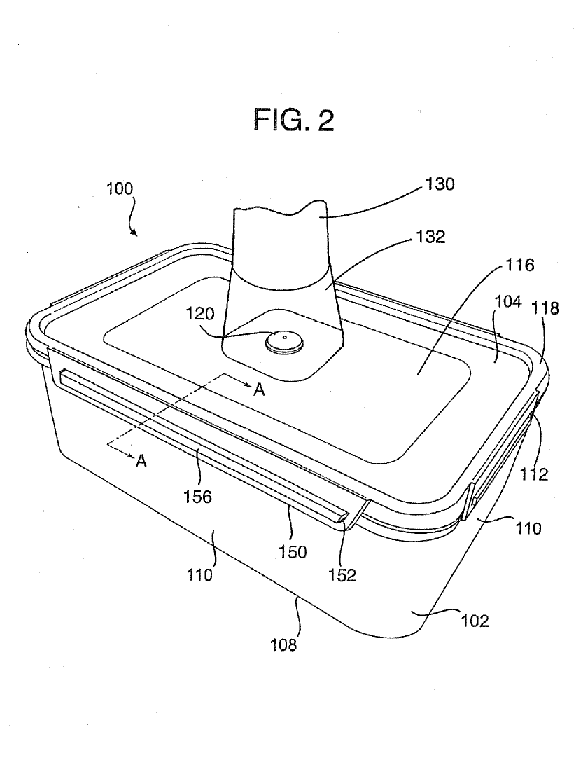

Referring to FIG. 2, the detachable lid 104 can be connected to the base 102 to cover the opening 114 and thereby enclose the storage cavity 106. While the illustrated lid is substantially planar, in other embodiments it may be domed or otherwise shaped to provide head room within the enclosed storage cavity. The lid 104 as illustrated can include a central portion 116 that extends over the opening and a peripheral connection feature 118 extending about the periphery of the lid that can releasably couple with the rim 112 to facilitate the detachable connection with the base 102. Accordingly, in the illustrated embodiment, the lid has a rectangular shape that generally corresponds in size and outline to the rim 112. However, in other embodiments, the storage container can have any suitable shape with any number and arrangement of sidewalls and the lid can have any suitable corresponding size and outline. The lid may be shaped to increase or decrease the head room within the container cavity. The use of a vacuum device may result in reduction of the head room.

The base 102 and lid 104 can be made from any suitable material. For example, the base and lid can be made from a rigid or semi-rigid thermoplastic material such as polypropylene, polyethylene, polyethylene trephthalater, nylon, polystyrene, ethylene vinyl acetate (EVA); or combinations thereof. The rigid or semi-rigid nature of the material allows the container to support itself in a freestanding manner. The actual thickness of the material forming the base wall, sidewalls, and planar portion of the lid can be selected so as to optimize the self-supporting character of the storage container. For example, the thickness of the walls can be in a first range from about 0.2 to about 2.5 mm and in a second range from about 0.4 to about 1.5 mm. In one embodiment, the thickness of the walls can be about 1.2 mm. The materials of the base and lid can be opaque or can be wholly or partially transparent or translucent to permit viewing of the contents of the storage container.

In one embodiment, the storage container 100 can be configured to enable evacuation of the storage cavity to better preserve any stored food items. To accomplish this, the lid 104 of the container can be equipped with a one-way valve element 120 that allows air to be withdrawn from within the storage cavity but that prevents environmental air from entering back into the cavity. Referring to FIG. 1, the valve element 120 can be an umbrella type valve element made from a flexible material such as rubber and which includes a flexible circular skirt 122 and a neck 124 projecting from the center of the skirt. To attach the valve element 120 to the lid 104, there can be disposed through the lid three holes or apertures 126. The neck 124 of the valve element 120 is inserted into the center aperture 126 to retain the valve element to the lid 104 so that the flexible skirt 122 overlays and covers the remaining apertures.

To draw air through the valve element 120, the storage container 100 can be interfaced with the nozzle 132 of a vacuum device 130. The vacuum device 130 is configured with an airflow generating unit which draws or sucks air through the nozzle 132 and exhausts that air to the environment, which thereby lowers the pressure within the nozzle. When the nozzle 132 is placed about the valve element 120 and the vacuum device 130 is activated, a pressure differential is created across the valve element between the nozzle and the storage cavity. This pressure differential causes the flexible skirt 122 to lift from the lid 104 and uncover the apertures 126. Air from the storage cavity then passes via the uncovered apertures into the nozzle 132 of the vacuum device 130. Once the vacuum device 130 is deactivated or the pressure differential is otherwise eliminated, the resiliency of the flexible valve element material causes the flexible skirt 122 to cover the apertures 126 thereby preventing air from re-entering the storage container 100. While the illustrated valve element is an umbrella-type valve element, in other embodiments the valve element can be any suitable type of valve element including a diaphragm valve element, a flexible multi-ply valve element, or a rigid valve element including a moving disc. Other embodiments may include other configurations for the valve and the valve seat, including other configurations of holes or apertures. In one embodiment, referring to FIG. 7, a single aperture 426 may be used to fasten the valve 420 to the lid 404 and the same aperture 426 may be used for fluid communication between the container cavity and the evacuation device 430. Furthermore, in other embodiments, the storage container can be evacuated in a variety of other suitable ways or can be configured with no evacuation features.

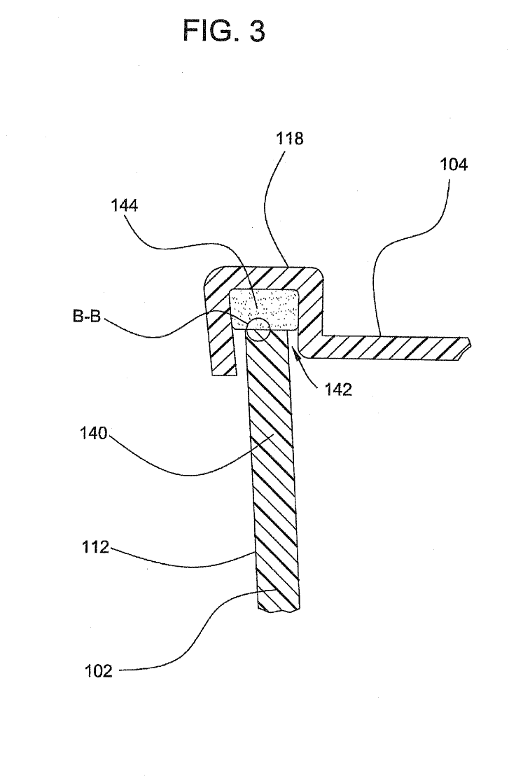

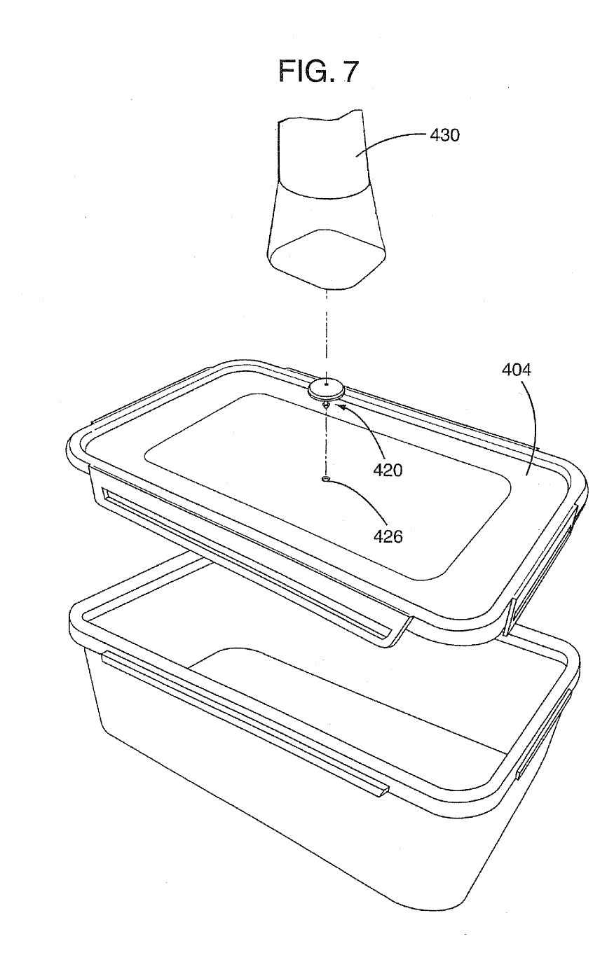

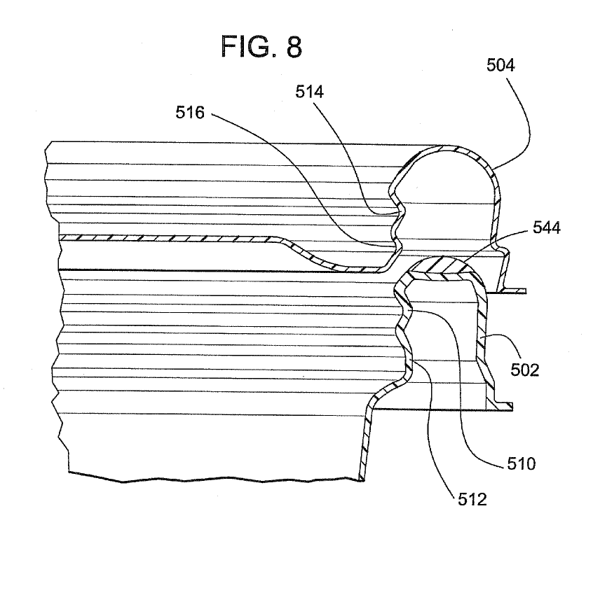

To further preserve food items stored in the container, it is desirable to make the detachable connection between the base 102 and the lid 104 airtight. This feature is further advantageous in storage container embodiments that can be evacuated. To facilitate the airtight connection, the storage container 100 can include a sealing member which can interact with the releasable coupling between the base and the lid. For example, referring to FIG. 3, the releasable coupling between the rim 112 on the base 102 and the connection feature 118 on the lid 104 can include a tongue and groove feature, though in other embodiments other suitable coupling profiles are contemplated. In the embodiment shown, the upward directed rim 112 provides a tongue 140 while a three-sided U-shaped groove 142 is disposed into and about the periphery of the lid 104. The groove 142 can receive and accommodate the tongue 140 when the base and lid are attached. In one embodiment, the generally parallel side legs of the U-shaped groove 142 can slightly squeeze the rim 112 to provide a retention force helping to keep the lid and base together, such as, by an interference fit. In another embodiment, the lid and base may include undercuts. For example, referring to FIG. 8, the base 502 may include undercuts 510, 512. The lid 504 may include undercuts 514, 516 which may engage undercuts 510, 512. The base 502 may include a sealing member 544. Referring to FIG. 3, the sealing member 144 can be located within or between the rim 112 and the connection feature 118 so that when the tongue 140 is inserted into the groove 142 it contacts against the sealing member 144. This contact helps provide a stable and substantially airtight seal between the lid and the base.

Moreover, the material of the sealing member can be any suitable material which demonstrates elastomeric or resilient qualities that further enable the sealing member to compress, displace and urge against the rim and the connection feature. Specifically, the material of the sealing member can be selected so as to demonstrate comparative resilience or compliance with respect to the materials of the lid and base components. As will be appreciated, such interaction between the complaint sealing member and the rim and connection feature helps produce a substantially airtight coupling between the base and lid. The sealing member may be a thermoplastic elastomer (“TPE”) or a closed cell foam, such as, foamed polyurethanes, polypropylenes, rubbers or polyvinyl chloride. Examples of TPE's may include: (1) block copolymers, such as, styrene butadiene-styrene triblocks, copolyesters, polyurethanes and polyamides; (2) elastomer/thermoplastic blends, such as, elastomer thermoplastic (TEO) blends with 20-30 parts of rubber based ethylene-propylene-diene monomer (EPDM) in a continuous phase of 70-80 parts of plastic such as isotactic polypropylene; (3) elastomeric alloys, such as, elastomeric alloys (EA) which are highly vulcanized rubber systems with vulcanization having been done dynamically in the melted plastic phase; (4) fluoropolymer elastomers; or (5) silicone elastomers. To facilitate the resilient characteristic, the TPE material can have any suitable hardness value demonstrating sufficient compliance and resilience such as hardness value in a range of about 3 to about 80 Shore A. In one embodiment, the hardness value may be about 65 Shore A.

To help prevent unintentional displacement of the sealing member and to simplify manufacturing of the storage container, the sealing member can be integrally bonded to either the rim or the connection feature. One advantage of integrally bonding the sealing member is that relatively good adhesion occurs between the sealing member and the storage container component. The bonding can help prevent the sealing member from being removed or separated from the groove or connection feature when the lid and the base are detached. The bonding can also help align the sealing member with the rim and connection feature so as to improve the airtight coupling. Another advantage of integral bonding is that the sealing member and the storage component can be formed during the same manufacturing process. This can both simplify assembly and reduce part and labor costs. In some embodiments, the integral bonding can take the form of an intermolecular bonding in which the materials of the storage container component and the sealing member can intermix or mingle on a molecular scale.

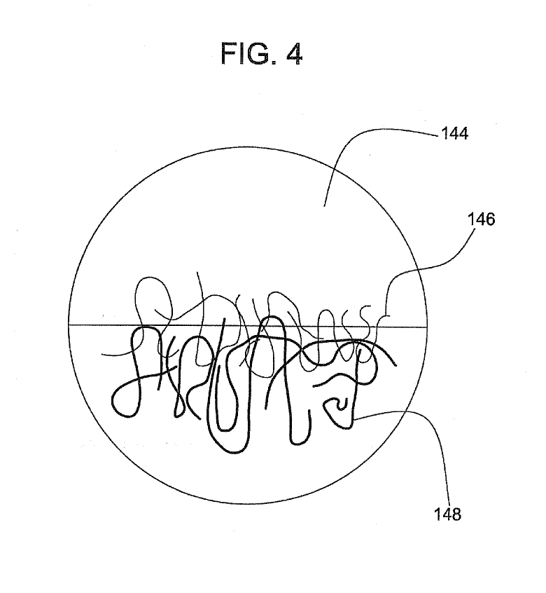

For example, in the embodiment illustrated in FIG. 3, the sealing member 144 is partially received in the connection feature 118, such as, the groove 142, and integrally bonded therewith. To produce the integral bonding, the sealing member 144 and lid 104 can be co-formed by an overmolding process. Such a process is described in the article entitled “Fundamentals and Material Development for Thermoplastic Elastomer (TPE) Overmolding,” reprinted in Journal of Injection Molding Technology, March 2000 (Vol. 4, No. 1), which is incorporated by reference herein in its entirety. In the overmolding process, the lid 104 including the groove 142 is first formed by a suitable procedure such as injection molding or vacuum forming. The melted or liquefied TPE material of the sealing member is then wetted to a sealing member receiving surface such as, for example, the surface of the groove. After wetting, the molecules of the TPE material next diffuse into the surface of the groove forming an interphase region therebetween in which the molecules of the two materials are intermixed. The results of this diffusion are illustrated in FIG. 4, wherein some or at least portions of the long TPE molecule chains 146 disperse into and inter-tangle with the bulk molecules 148 of the storage container component hence forming an interphase between the two materials. Bonding is further strengthened when the two materials interact by forming covalent bonds or hydrogen bonds. The TPE material is then allowed to set or solidify such that the portion of the TPE material which has not diffused into the groove surface can form the sealing member 144.

In another embodiment, to provide the integral bonding between the sealing member and either the base or lid, the materials of the two components can be co-extruded. In such a process, the different materials that form both the sealing member and base or lid can first be melted or liquefied and extruded onto a sealing member receiving surface on the sheet or profile so that the materials form integrally bonded parts. The sheet or profile may then be thermoformed into the desired shape.

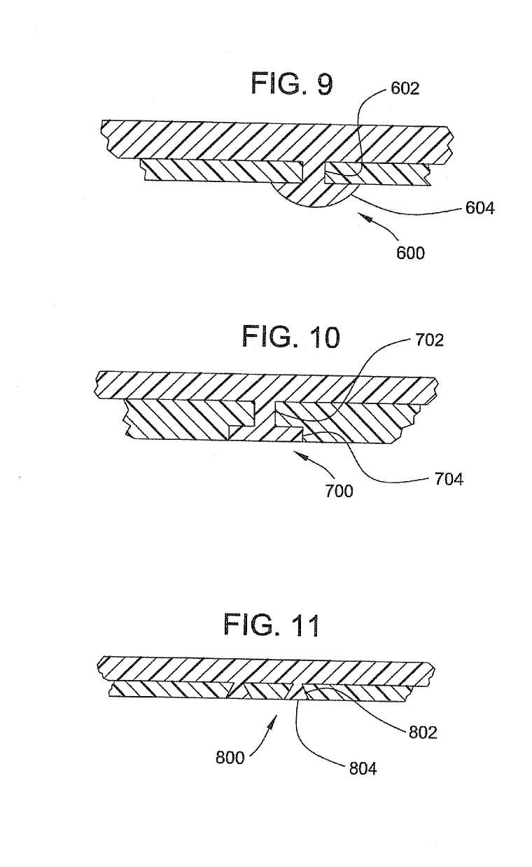

In another embodiment, the bond, between the sealing member and either the base or lid, may also include a mechanical bond. For example, the mechanical bond may be an anchor. Referring to FIG. 9, the anchor 600 may extend through an aperture 602 in the base or lid. The anchor may extend beyond the surface of the base or lid and may include a head 604 which is larger than the aperture 602 in order to prevent removal of the anchor 600 from the base or lid. Referring to FIG. 10, the anchor 700 extends through the aperture 702 and into a counter bore 704. The counter bore 704 is larger than the aperture 702 in order to prevent removal of the anchor 700 from the base or lid. The anchor 700 may be flush with the surface of the base or lid. In another embodiment, the anchor may extend beyond the surface of the base or lid. Referring to FIG. 11, the anchor 800 extends into a tapered aperture 802. The aperture 802 is wider at the distal end 804 to prevent removal of the anchor 800 from the base or lid.

Referring back to FIGS. 1 and 2, to further enhance the releasable attachment between the base 102 and the lid 104, the lid can include one or more latches 150 hingedly connected about the peripheral connection feature 118 of the lid 104. The latches 150 can be elongated members extending partially along the edges of the lid 104 and can be pivoted to depend downwards from the planar portion of the lid. Further, each latch 150 may include an elongated slot 152 disposed therethrough. To mate with the slots 152, the base 102 can include a corresponding number of elongated bars or rails 156 projecting outwards from proximate the rim 112 of the base and that are sized and located so as to be received in the slots 152. Thus, when the latches 150 are pivoted downwards, the slots 152 receive the rails 156 thereby temporarily securing the lid 104 to the base 102. Furthermore, the engagement between the rails 156 and slot may function to pull the lid into tighter proximately with the base thereby further compressing the sealing member and thus improving the air tight seal. To detach the lid 104 from the base 102, the latches can simply be pivoted upwards.

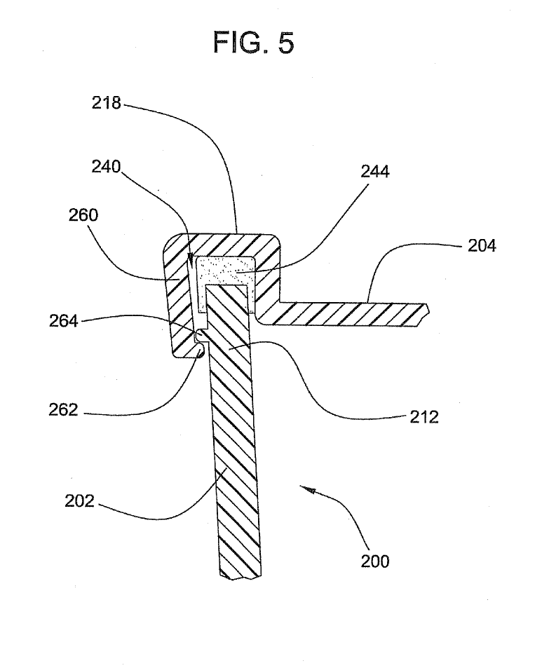

Referring to FIG. 5, there is illustrated in cross-section another embodiment of a releasable coupling between a base 202 and a lid 204 of a storage container 200 which involves a sealing member 244. In the illustrated embodiment, the sealing member 244 may be integrally bonded to the upward directed rim 212 of the base 202. The sealing member 244 can extend about all three sides or surfaces of the rim. Thus, when the rim 212 is inserted into the U-shaped groove 240 provided by the peripheral connection feature 218 of the lid 204, the sealing member may be resiliently compressed or displaced therebetween thus providing a substantially airtight seal. In the present embodiment, the sealing member 244 can be integrally bonded to the rim 212 by either overmolding or co-extrusion.

To further enhance the releasable attachment between the base 202 and the lid 204, the releasable coupling can be implemented as a snap fit relationship. Specifically, the outermost leg or flange 260 of the U-shaped groove 240 can include an inward directed first protrusion 262 formed near its distal end. The rim 212 can include a corresponding outwardly directed second protrusion 264 that can be offset a given distance from the uppermost point of the rim. Hence, when the rim 212 is received into the U-shaped groove 240, the first and second protrusion 262, 264 slide past one another and then interlock. In other embodiments, the releasable coupling of the rim and connection portion can be facilitated by other suitable methods such as, for example, screw threads, or undercuts as shown in FIG. 8.

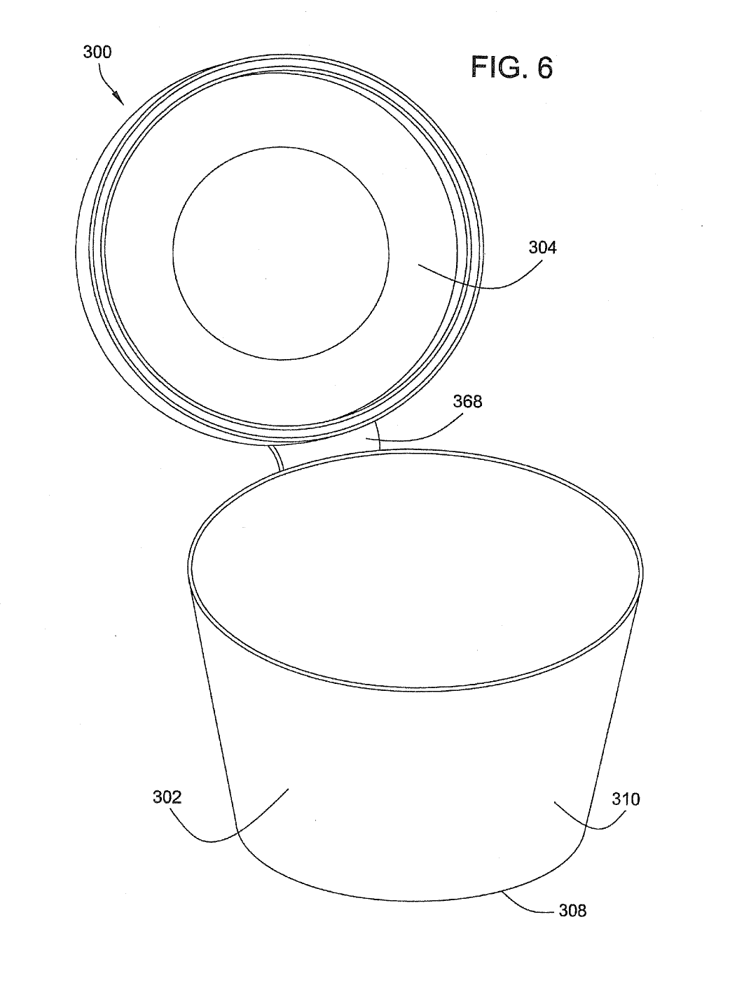

Referring to FIG. 6, there is illustrated another embodiment of a storage container 300 for receiving and storing food items which can include a base 302 and a detachable lid 304. To receive the food items, the base 302 may include a base wall 308 and an upward extending, sidewall 310 which provides the base with a tub-like shape. Moreover, the sidewall 310 can be generally tapered such that multiple tubs can be stacked together. To fit with the tub-like base 302, the lid 304 can have a corresponding circular shape. In this illustrated embodiment, rather than being completely detachable, the base 302 and lid 304 can be connected by a living hinge 368 that enables articulation between the base and the lid for accessing and enclosing the storage cavity. In other embodiments, the storage container can be dish-shaped, bowl-shaped or any other suitable shape. The sealing member can be integrally bonded to either the base or lid as described herein.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Exemplary embodiments of this invention are described herein. Variations of those embodiments may become apparent to those of ordinary skill in the art upon reading the foregoing description. The inventor(s) expect skilled artisans to employ such variations as appropriate, and the inventor(s) intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A storage container comprising:
a base including at least one base wall having a generally upward directed rim delineating an opening, the base wall further providing at least a portion of a storage cavity accessible by the opening; and
a lid connectable with the base for covering the opening, the lid including a peripherally located connection feature that releasably couples with the rim;
wherein, at least one of the rim and the connection feature includes a sealing member integrally bonded therewith.

2. The storage container of claim 1, wherein the releasably coupling between the connection feature and the rim is a tongue and groove coupling.

3. The storage container of claim 2, wherein the both the connection feature and the rim contain undercuts.

4. The storage container of claim 2, wherein the sealing member is at least partially received in the groove.

5. The storage container of claim 1, wherein the integral bond between the sealing member and at least one of the rim and the connection feature is an intermolecular bond.

6. The storage container of claim 1, wherein the sealing member includes a thermoplastic elastomer (TPE).

7. The storage container of claim 1, wherein the sealing member includes a closed cell foam.

8. The storage container of claim 1, wherein the sealing member includes a thermoplastic elastomer.

9. The storage container of claim 1, wherein at least one of the base and lid includes a one-way valve element for enabling evacuation of the storage cavity.

10. A storage container comprising:
a base including at least one base wall having a generally upward directed rim delineating an opening, the base wall further providing at least a portion of a storage cavity accessible by the opening; and
a lid connectable with the base for covering the opening, the lid including a peripherally located connection feature that releasably couples with the rim;
wherein the lid includes one or more latches hingedly connected about the peripherially located connection feature.

11. The storage container of claim 10, wherein at least one of the rim and the connection feature includes a sealing member integrally bonded therewith.

12. The storage container of claim 10, wherein the storage container is a thermoplastic container.

13. The storage container of claim 10, wherein the releasable coupling between the connection feature and the rim is a tongue and groove coupling.

14. The storage container of claim 13, wherein the both the connection feature and the rim contain undercuts.

15. The storage container of claim 10, wherein at least one of the base and lid includes a one-way valve element for enabling evacuation of the storage cavity.

16. The storage container of claim 15, wherein the storage container is a thermoplastic container.

17. The storage container of claim 15, wherein the releasable coupling between the connection feature and the rim is a tongue and groove coupling and wherein the both the connection feature and the rim contain undercuts.

18. A method of manufacturing a storage container comprising:
(i) molding or extruding a first storage container component including at least one of a rim or peripheral connection feature, the rim or peripheral connection feature including a sealing member receiving surface;
(ii) co-molding or co-extruding integrally with the sealing member receiving surface a sealing member;
(iii) connecting a second storage container component to the first storage container component by releasably coupling a second connection feature of the second storage container component with the rim or peripheral connection feature.

19. The method of claim 18, wherein the material of the sealing member includes a thermoplastic elastomer (TPE).

20. The method of claim 18, wherein the sealing member includes a closed cell foam.
